(19) United States
(12) Patent Application Publication
(10) Pub. No.: US 2022/0114189 A1
(43) Pub. Date: Apr. 14, 2022

(54) EXTRACTION OF STRUCTURED INFORMATION FROM UNSTRUCTURED DOCUMENTS

(71) Applicant: International Business Machines Corporation, Armonk, NY (US)

(72) Inventors: Michael Baessler, Bempflingen (DE); Albert Maier, Tuebingen (DE); Dirk Jahn, Wiesbaden (DE); Thomas Hampp-Bahnmueller, Stuttgart (DE)

(21) Appl. No.: 17/069,892

(22) Filed: Oct. 14, 2020

(51) Int. Cl. G06F 16/25; G06F 16/93; G06F 40/242; G06Q 10/10; G06F 16/22; G06F 40/279

(52) U.S. Cl. CPC G06F 16/254; G06F 16/93; G06F 40/242; G06F 16/2282; G06F 16/221; G06F 40/279; G06Q 10/105

(57) ABSTRACT

Embodiments of the present invention provide methods, computer program products, and systems. Embodiments of the present invention can extract of structured information for unstructured document analysis. Embodiments of the present invention can extract structured information for unstructured document analysis by identifying tables and columns of a database that correspond to business terms of a business glossary. Embodiments of the present invention can then receive a specification of business terms of interest for recognizing in an unstructured document. Embodiments of the present invention can then generate an analysis module based on the identified tables and columns that enables to identify or recognize attribute values of attributes of the tables and columns. Embodiments of the present invention can then use the analysis module for automatic extraction of values of at least part of the attributes from the unstructured document based on the specification of business terms of interest.

### BACKGROUND

The present invention relates to the field of digital computer systems, and more specifically, to a method for extraction of structured information from unstructured documents.

The number of unstructured documents used for data analysis is exponentially increasing. However, unstructured documents may not be queried in simple ways which considerably limits the extraction of the knowledge contained in such documents.

### SUMMARY

Various embodiments provide a method for extraction of structured information from unstructured documents, computer system and computer program product as described by the subject matter of the independent claims. Advantageous embodiments are described in the dependent claims. Embodiments of the present invention can be freely combined with each other if they are not mutually exclusive.

In one aspect, the invention relates to a computer implemented method for extraction of structured information for unstructured document analysis. The method comprises: identifying tables and columns of a database that correspond to business terms of a business glossary; receiving a specification of business terms of interest for recognizing in an unstructured document; generating an analysis module based on the identified tables and columns that enables to identify or recognize attribute values of attributes of the tables and columns; and using the analysis module for automatic extraction/detection of values of at least part of the attributes from the unstructured document based on the specification of business terms of interest.

In another aspect, the invention relates to a computer program product comprising a computer-readable storage medium having computer-readable program code embodied therewith, the computer-readable program code configured to implement all of the steps of the method according to preceding embodiments.

In another aspect, the invention relates to a computer system configured for: identifying tables and columns of a database that correspond to business terms of a business glossary; receiving a specification of business terms of interest for recognizing in an unstructured document; generating an analysis module based on the identified tables and columns that enables to identify or recognize attribute values of attributes of the tables and columns; and using the analysis module for automatic extraction/detection of values of at least part of the attributes from the unstructured document based on the specification of business terms of interest.

The present subject matter may enable to extract structured information from unstructured documents using computer implemented methods. This may enable an automated discovery of relevant information from unstructured documents into structured information. This may make structured information available in time to users such as data scientists. The present subject matter may save resources that would otherwise be required to perform an ad-hoc extraction of structured information from the unstructured document. This may particularly be advantageous as the number of unstructured documents to be analyzed is constantly increasing.

### BRIEF DESCRIPTION OF THE DRAWINGS

In the following embodiments of the invention are explained in greater detail, by way of example only, making reference to the drawings in which:

FIG. 1 is a block diagram of a computer system, in accordance with an embodiment of the present invention.

FIG. 2 is a flowchart of a method for extraction of structured information from unstructured documents, in accordance with an embodiment of the present invention.

FIG. 3 is a flowchart of a method for extraction of structured information from unstructured documents, in accordance with an embodiment of the present invention.

FIG. 4 is a flowchart of a method for extraction of structured information from unstructured documents, in accordance with an embodiment of the present invention.

FIG. 5 represents a computerized system, suited for implementing one or more method steps, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The business glossary may comprise a list of business terms with their definitions. The business glossary defines terms across a business domain. For example, the business glossary defines business concepts for an organization or industry. The business glossary may enable to share internal vocabulary within an organization.

By contrast to a structured document, the unstructured document may comprise unstructured information that either does not have a predefined data model or is not organized in a predefined manner. This may make difficult an understanding of such documents using programs as compared to data stored in fielded form in databases or annotated in documents of structured documents. The unstructured document may, for example, be an electronic document. The electronic document may be an electronic media content that is intended to be used in either an electronic form or as printed output. The electronic document may comprise, for example, a web page, a document embedded in a web page and that may be rendered in the web page, spreadsheet, email, book, picture, and presentation that have an associated user agent such as a document reader, editor or media player.

The analysis module may, for example, be a software module. The analysis module may comprise for each attribute of the identified tables and/or columns a corresponding logic or piece of software that enables to recognize values as being values of said attribute or not. The identified tables and/or columns may comprise one or more sets of records, wherein each set of records of the sets of records represents a respective distinct entity type e.g. one set of records may be associated with companies, another set of records may be associated with customers etc. The analysis module may, for example, be configured to determine the entity type that is represented by a given attribute value in the unstructured document. The extracted values of the at least part of the attributes may be provided as structured information by organizing them as records associated with respective entity types.

Identifying tables and/or columns of a database that correspond to business terms of the business glossary comprises: for each business term of the business glossary identifying at least one column and/or at least one table that corresponds to the business term. For example, if the business term is “address” and the database comprises a table “address” consisting of “street”, “zip” and “city” columns, the whole table may be identified as corresponding to the business term “address”. In this case, the attributes “street”, “zip” and “city” are the identified attributes that correspond to the business term “address”. In another example, if the business term is “company” and the database comprises a table “employees” consisting of “name”, “age” and “employing company” columns, the column “employing company” may be identified as corresponding to the business term “company”. If the database further comprises a table named “companies” having columns “company name”, “location” etc. the column “company name” may further be associated with the business term “company”. In this case, two columns are identified as being associated with the business term “company” and the identified attributes that correspond to the business term “company” are the attributes “employing company” and “company name”. The values of those two attributes “employing company” and “company name” may (collectively) be used to generate the analysis module such that it can determine whether or not a value is an attribute value of at least one of the “employing company” and “company name” attributes. Thus, identifying tables and/or columns of a database that correspond to business terms of the business glossary comprises identifying attributes of the database that correspond to the business terms.

According to one embodiment, the identifying of the tables and/or columns comprises: for each term of the business terms, determining an identification logic based on a format and/or content of the business term, and running the identification logics on the database for identifying the tables and/or columns. The identification logic may, for example, comprise a regular expression that may be used to detect a certain string as a product identifier.

According to one embodiment, generating the analysis module comprises building a dictionary of the business terms using attribute values of the identified tables and/or columns, wherein using the analysis module to extract the structured information comprises comparing the content of the unstructured document with the dictionary. The dictionary may, for example, provide attribute values associated with each term of the business glossary as detailed information of the term.

According to one embodiment, generating the analysis module comprises building a logic based on the content and/or format of the attribute values of the identified tables and/or columns such that the logic can recognize values similar to the attribute values. The analysis module comprises the logic. The analysis module may, for example, be automatically generated.

For example, a data profiling of the attribute values of each attribute type of the identified tables and/or columns may be performed. The data profiling may, for example, comprise a format analysis and/or data properties analysis. The format analysis of the values of an attribute type may create a format expression for the values of the attribute type. A format expression may be a pattern that contains a character symbol for each distinct character in a column. The data properties analysis may determine data properties of the attribute values. Data properties define the characteristics of data such as field length or data type. The results of the data profiling may be used to generate the logic e.g. regular expressions may be built based on the results of the data profiling.

In one example, the analysis module may comprise the dictionary and the logic and both (the dictionary and the logic) may be used for automatic extraction of values of the attributes of the identified tables and/or columns as a structured information from the unstructured document.

According to one embodiment, the method further comprises: updating the analysis module based on one or more changes in the database and/or the business glossary, and repeating the method using the updated module for extraction of structured information from the unstructured document and/or from another unstructured document. For example, the updating is automatically performed in response to detecting the changes. The data is changing frequently so creating and keeping an analysis entity up to date for unstructured content may be technically challenging. This embodiment may provide an automatically generated analysis module with automated updates.

According to one embodiment, the update is performed if the number of changes is higher than a threshold. For example, the updating may automatically be performed if the number of changes is higher than the threshold.

According to one embodiment, the extraction of structured information comprises identifying the values of the attributes in the unstructured documents that correspond to attribute values of the identified tables and/or columns and forming from said values records associated with respective entities in accordance with the entities of the identified tables and/or columns. For example, the extracted information may be provided as a table or relational table.

According to one embodiment, the method further comprises repeating the method for a further unstructured document wherein the identification of the tables and/or columns is performed in the database and in the formed records. This embodiment may enable a self-improving system based on previously processed unstructured documents.

According to one embodiment, the analysis module may be a plugin. The plugin may be a software component that adds a specific feature to an existing computer program. This may enable customization of existing programs with the present subject matter.

According to one embodiment, the database is a master data management (MDM) database. This may enable a seamless integration of the present subject matter with existing systems e.g. making use of their databases.

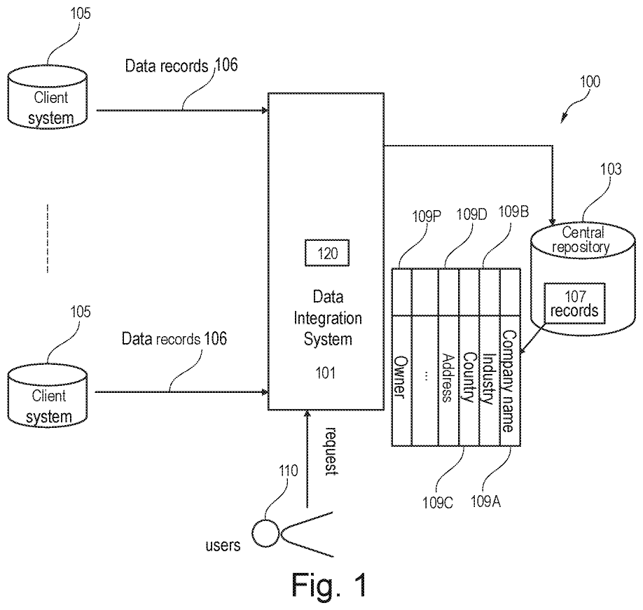

FIG. 1 depicts an exemplary computer system 100. The computer system 100 may, for example, be configured to perform master data management and/or data warehousing. The computer system 100 comprises a data integration system 101 and one or more client systems 105 or data sources 106. The client system 105 may comprise a computer system. The client systems 105 may communicate with the data integration system 101 via a network connection which comprises, for example, a wireless local area network (WLAN) connection, WAN (Wide Area Network) connection, LAN (Local Area Network) connection the internet or a combination thereof. The data integration system 101 may control access (read and write accesses etc.) to a central repository 103 or database.

Data records stored in the central repository 103 may have values of a set of attributes 109A-P such as a company name attribute. Although the present example is described in terms of few attributes, more or less attributes may be used.

Data records stored in the central repository 103 may be received from the client systems 105 and processed by the data integration system 101 before being stored in the central repository 103. The received records may or may not have the same set of attributes 109A-P. For example, a data record received from client system 105 by the data integration system 101 may not have all values of the set of attributes 109A-P e.g. the data record may have values of a subset of attributes of the set of attributes 109A-P and may not have values for the remaining attributes. In other terms, the records provided by the client systems 105 may have different completeness. The completeness is the ratio of number of attributes of a data record comprising data values to a total number of attributes in the set of attributes 109A-P. In addition, the received records from the client systems 105 may have a structure different from the structure of the stored records of the central repository 103. For example, a client system 105 may be configured to provide records in XML format, JSON format or other formats that enable to associate attributes and corresponding attribute values.

In another example, data integration system 101 may import data records of the central repository 103 from a client system 105 using one or more ETL batch processes or via HyperText Transport Protocol (“HTTP”) communication or via other types of data exchange.

The data integration system 101 may be configured to receive requests from a user 110 to perform a certain analysis of an unstructured document. The request may, for example, specify business terms of interest for the user 110. For example, the data integration system 101 may process stored data records 107 using the algorithm 120 in accordance with the present subject matter.

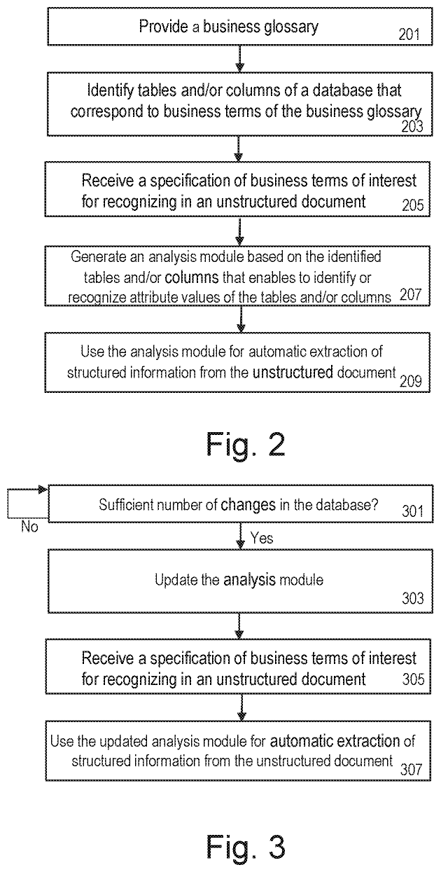

FIG. 2 is a flowchart of a method for extraction of structured information from unstructured documents in accordance with an example of the present subject matter. For the purpose of explanation, the method described in FIG. 2 may be implemented in the system illustrated in FIG. 1 but is not limited to this implementation. The method of FIG. 2 may, for example, be performed by the data integration system 101.

A business glossary may be provided in step 201. The business glossary may be adapted for data governance. The business glossary may comprise a list of business terms with their definitions. The business glossary defines business concepts for an organization or industry. The business glossary may enable to share internal vocabulary within an organization.

Stored records 107 (e.g., tables and/or columns) of a database such as central repository 103 that correspond to business terms of the business glossary may be identified in step 203. Identifying the tables and/or columns results in identifying records of said tables and/or columns. Identifying the table and/or column associated with each business term may comprise mapping the business term to said table and/or column. For example, each of the terms of the business glossary may be mapped to a corresponding table and/or column of the database. This mapping may, for example, be performed using a software such as IBM Cloud Pak for Data. The records associated with said tables and columns may be the identified records of step 203. Each of the identified records may be associated with a respective entity. For example, for a specified term such as “address”, a table e.g. named “ADDRESS” consisting of columns consisting of “street”, “zip” and “city” columns may be identified. All records of the identified table “ADDRESS” may be the identified records of step 203 as the whole table is related to address related features. Each record of the identified table may have values of a set of one or more attributes such as street, zip, city etc. Each record of the table may be associated with a respective entity which is an address entity type. In this example, step 203 may result in identifying attributes “street”, “zip” and “city” as being associated with the business term “address”. In another example, for a specified term such as “startup”, a column or attribute of the central repository 103 named “employing company” may be mapped to said term. The column may belong to a table such as a table named “EMPLOYEES”. The table “EMPLOYEES” may comprise additional attributes such as the name of the person, the location of the person etc. Each record of the table “EMPLOYEES” may be associated with a respective entity which is a person. In this case, all records of the table “EMPLOYEES” may be the identified records in step 203, wherein each record of the all records may comprise one attribute value which is the value of the attribute “employing company”. That is, an identified record of step 203 may have a value of the attribute “employing company” of a respective record of the table “EMPLOYEES”. In this example, step 203 may result in identifying attribute “employing company” as being associated with the business term “company”. If the database further comprises a table named “companies” having columns “company name”, “location” etc. the column “company name” may further be associated with the business term “company”. Each record of the table “COMPANIES” may be associated with a respective entity which is a company.

Customers may, however, be interested in specific information that is relevant for them such as product names, customer names, employee names etc. Thus, a specification of business terms of interest for recognizing in an unstructured document may be received in step 205. The specification of business terms may be a request of the business terms that is, for example, received from the user 110. For example, the user 110 may be interested in companies that have been documented in a book or other unstructured documents. The specified business terms may, for example, be terms of the business glossary. For example, the specification of the business terms in the unstructured document may be received in response to loading the unstructured document into a governed data lake. This may, for example, make data available in time for scientists.

An analysis module may be generated in step 207 based on the attributes of the identified tables and/or columns. The generated analysis module may enable to identify or recognize attribute values of the identified records. For example, for each attribute type of the identified tables and/or columns, the analysis module may comprise a logic or data class that enables to recognize values of said attribute type. The logic may, for example, be a piece of code e.g. comprising regular expressions. The analysis module may be configured to read an input value and to determine whether the input value is a value of one of the attribute types of the identified records. Following the example of the identified attribute “employing company”, the analysis module may be generated such that it can determine whether a value is a value of the attribute “employing company” or not. For that, the values of the identified column “employing company” may be used to generate the module. If the database further comprises the table named “companies” the values of the identified column “employing company” and/or “company name” may be used (profiled) to generate the module.

The analysis module may be generated automatically or semi-automatically. In one first module generation example, a data profiling of the attribute values of each attribute type of the identified tables/or columns may be performed. In one example, the profiling may be performed for values of more than one attribute types that have been identified as being associated with a same business term in step 203. The data profiling may, for example, comprise a format analysis. The format analysis of the values of an attribute type may create a format expression for the values of the attribute type. A format expression may be a pattern that contains a character symbol for each distinct character in a column. For example, each alphabetic character might have a character symbol of A and numeric characters might have a character symbol of 9. The format expression may be used to generate a logic that identifies such a pattern e.g. the logic may be configured to map the pattern with input values. In one second module generation example, a user may be prompted with the values of one or more attribute types of the identified tables/or columns or prompted with the results of the data profiling of said values and in response defined logics may be received from the user, wherein each of the defined logics may be configured to identify or recognize values that correspond to the respective attribute type. Thus, the analysis module may be generated in accordance with the first module generation example and/or the second module generation example.

In one example, the generation of the analysis module may be performed after receiving the specification of step 205. This may be advantageous as it may provide the analysis module on-demand. For example, the analysis module may be generated based only on attribute types of the identified tables/or columns that are related to the specified business terms. This may save resources that would otherwise be required for generating a module for all attribute types. In another example, the generation of the analysis module may be performed up-front e.g. before step 205. This may prevent creating the module for each received request e.g. a single generated module may be used for multiple received specifications such as the received specification of step 205. For example, after generating the analysis module, steps 205 and 209 may be repeated one or more times using the same generated analysis module for extracting structure information from same or different unstructured documents.

The analysis module may be used in step 209 for detection and extraction of information from the unstructured document based on the specification of business terms of interest. The detected and extracted information may be values of the attribute types whose values are identified by the analysis module. The detected and extracted information may be referred to as structured information. The detected and extracted information may be provided to the user in a structured format such as a table. The extracted information may comprise attribute values, wherein each attribute value is associated with one or more entity types. For example, in case the requested business term is about companies, the values in the unstructured document that are identified as values of the attribute “employing company” or “company name” may be associated with the entity “Person” and “Company” entities. Step 209 may, for example, be automatically performed e.g. upon receiving the specification of step 205 and generation of the module. For example, the unstructured document may be parsed, and each parsed value may be processed by the analysis module to determine whether that value is a value of one of the attribute types of the identified tables/or columns. This step may, for example, result in identification of multiple values of different attribute types. Each value of these multiple values may represent a respective one or more entities. For example, if the user requested information about companies, the analysis module may search values that correspond to attribute type “employing company” of the table because the analysis module is generated based on the values of the “employing company” attribute.

FIG. 3 is a flowchart of a method for extraction of structured information from unstructured documents in accordance with an example of the present subject matter. For the purpose of explanation, the method described in FIG. 3 may be implemented in the system illustrated in FIG. 1 but is not limited to this implementation. The method of FIG. 3 may, for example, be performed by the data integration system 101.

It may be determined in step 301 whether the number of changes in the central repository 103 exceeds a predefined threshold. The change may, for example, be caused by update and/or insertion operations. In case the number of changes in the central repository 103 does not exceed the predefined threshold, step 301 may be repeated until the number of changes in the central repository 103 exceeds the predefined threshold or until the number of repetitions reaches a maximum number of repetitions and thus the method may end if that maximum number of repetitions is reached. In case the number of changes in the central repository 103 exceeds the predefined threshold, the analysis module may be continually updated in step 303 using the changed central repository 103. The update of the analysis module may be performed by creating new logics and/or updating existing logics of the analysis module using the updated data. The update of the analysis module may be performed using at least one of the first and second module generation examples. A specification of business terms of interest for recognizing in an unstructured document may be received in step 305. For example, a user may be interested in companies that have been documented in a book or other unstructured documents. The specified business terms may, for example, be terms of the business glossary. The updated analysis module may be used in step 307 (e.g. as described with reference to step 209 of FIG. 2) for extraction of structured information from the unstructured document based on the specification of business terms of interest.

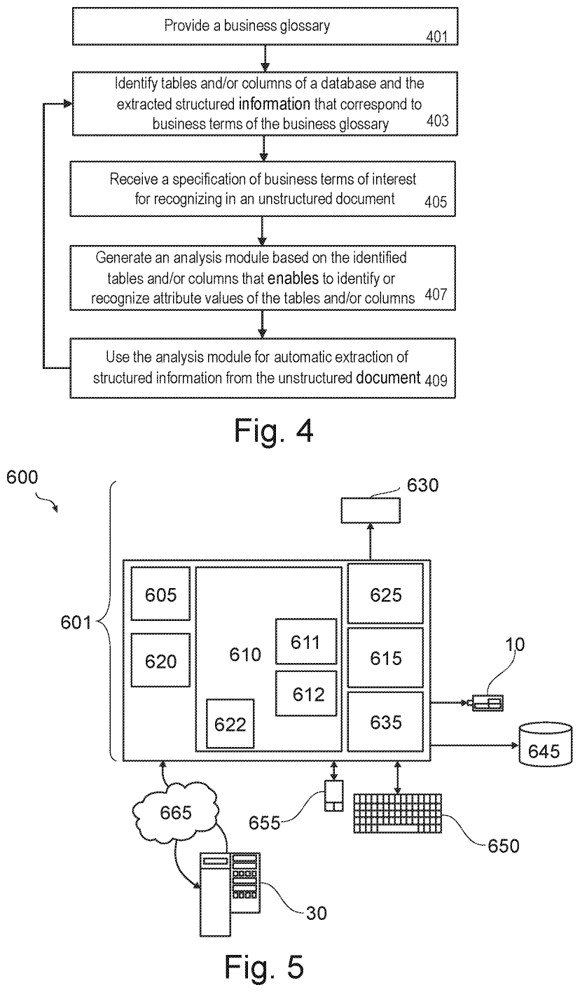

FIG. 4 is a flowchart of a method for extraction of structured information from unstructured documents in accordance with an example of the present subject matter. For the purpose of explanation, the method described in FIG. 4 may be implemented in the system illustrated in FIG. 1, but is not limited to this implementation. The method of FIG. 3 may, for example, be performed by the data integration system 101.

Steps 401 to 409 of FIG. 4 are steps 201 to 209 of FIG. 2 respectively. In addition, FIG. 4 comprises the repetition of steps 401 to 409, wherein in each repetition, step 403 identifies tables and/or columns of both the database and the structured information extracted in step 409 of the previous executions of step 409. The repetition of steps 401 to 409 may, for example, be performed on a periodic basis e.g. every day. In another example, the repetition of steps 401 to 409 may be performed until a predefined maximum number of repetitions is reached. The method of FIG. 4 may enable a self-improving system that improves over time using both databases and unstructured documents.

FIG. 5 represents a general computerized system 600 suited for implementing at least part of method steps as involved in the disclosure.

It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software 612, 622 (including firmware), hardware (processor) 605, or a combination thereof. In exemplary embodiments, the methods described herein are implemented in software, as an executable program, and is executed by a special or general-purpose digital computer, such as a personal computer, workstation, minicomputer, or mainframe computer. The most general system 600 therefore includes a general-purpose computer 601.

In exemplary embodiments, in terms of hardware architecture, as shown in FIG. 6, the computer 601 includes a processor 605, memory (main memory) 610 coupled to a memory controller 615, and one or more input and/or output (I/O) devices 10 (or peripherals), 645 that are communicatively coupled via a local input/output controller 635. The input/output controller 635 can be, but is not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 645 may generally include any generalized cryptographic card or smart card known in the art.

The processor 605 is a hardware device for executing software, particularly that stored in memory 610. The processor 605 can be any custom made or commercially available processor, a central processing unit (CPU), an auxiliary processor among several processors associated with the computer 601, a semiconductor-based microprocessor (in the form of a microchip or chip set), or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 610 can have a distributed architecture, where various components are situated remote from one another, but can be accessed by the processor 605.

The software in memory 610 may include one or more separate programs, each of which comprises an ordered listing of executable instructions for implementing logical functions, notably functions involved in embodiments of this invention. In the example of FIG. 5, software in the memory 610 includes instructions 612 e.g. instructions to manage databases such as a database management system.

The software in memory 610 shall also typically include a suitable operating system (OS) 411. The OS 611 essentially controls the execution of other computer programs, such as possibly instructions 612 (e.g., software) for implementing methods as described herein.

The methods described herein may be in the form of a source program, executable program (object code), script, or any other entity comprising a set of instructions 612 to be performed. When a source program, then the program needs to be translated via a compiler, assembler, interpreter, or the like, which may or may not be included within the memory 610, so as to operate properly in connection with the OS 611. Furthermore, the methods can be written as an object-oriented programming language, which has classes of data and methods, or a procedure programming language, which has routines, subroutines, and/or functions.

In exemplary embodiments, a conventional keyboard 650 and mouse 655 can be coupled to the input/output controller 635. Other output devices such as the I/O devices 645 may include input devices, for example but not limited to a printer, a scanner, microphone, and the like. Finally, the I/O devices 10, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 645 can be any generalized cryptographic card or smart card known in the art. The system 600 can further include a display controller 625 coupled to a display 630. In exemplary embodiments, the system 600 can further include a network interface for coupling to a network 665. The network 665 can be an IP-based network for communication between the computer 601 and any external server, client and the like via a broadband connection. The network 665 transmits and receives data between the computer 601 and external systems 30, which can be involved to perform part, or all of the steps of the methods discussed herein. In exemplary embodiments, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network W(LAN), a wireless wide area network (WWAN) a personal area network (PAN), a virtual private network (VPN), intranet or other suitable network system and includes equipment for receiving and transmitting signals.

If the computer 601 is a PC, workstation, intelligent device or the like, the software in the memory 610 may further include a basic input output system (BIOS) 622. The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software 612 stored within the memory 610, to communicate data to and from the memory 610, and to generally control operations of the computer 601 pursuant to the software. The methods described herein and the OS 611, in whole or in part, but typically the latter, are read by the processor 605, possibly buffered within the processor 605, and then executed.

When the systems and methods described herein are implemented in software 612, as is shown in FIG. 5, the methods can be stored on any computer readable medium, such as storage 620, for use by or in connection with any computer related system or method. The storage 620 may comprise a disk storage such as HDD storage.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
extracting of structured information for unstructured document analysis wherein extracting of structured information for unstructured document analysis comprises:
identifying tables and columns of a database that correspond to business terms of a business glossary;
receiving a specification of business terms of interest for recognizing in an unstructured document;
generating an analysis module based on the identified tables and columns that enables to identify or recognize attribute values of attributes of the tables and columns; and
using the analysis module for automatic extraction of values of at least part of the attributes from the unstructured document based on the specification of business terms of interest.

2. The computer-implemented method of claim 1, wherein identifying of the tables and columns comprises:
for each term of a plurality of business terms, determining an identification logic based on a format and content of a respective business term; and
running the identification logics on the database for identifying the tables and columns.

3. The computer-implemented method of claim 1, wherein generating the analysis module comprises:
building a dictionary of the plurality of business terms using attribute values of the identified tables and columns, wherein using the analysis module to extract the structured information comprises comparing content of the unstructured document with the dictionary.

4. The computer-implemented method of claim 1, wherein generating the analysis module comprises:
building a logic based on the content and format of the attribute values of the identified tables and columns such that the logic can recognize values similar to the attribute values.

5. The computer-implemented method of claim 1, further comprising:
updating the analysis module based on one or more changes in the database and the business glossary, and
continually updating the analysis module for extraction of structured information from the unstructured document and/or form another unstructured document.

6. The computer-implemented method of claim 5, wherein the update is performed if a number of changes is higher than a threshold.

7. The computer-implemented method of claim 1, wherein the extraction of structured information comprises:
identifying the values of the attributes in the unstructured documents that correspond to attribute values of the identified tables and columns; and
forming from the attribute values, records associated with respective entities in accordance with the entities of identified records.

8. The computer-implemented method of claim 7, further comprising:
repeating the computer-implemented method for a further unstructured document wherein the identification of the tables and columns is performed in the database and in the formed records.

9. The computer-implemented method of claim 1, the analysis module is a plugin.

10. The computer-implemented method of claim 1, wherein the database is a master data management (MDM) database.

11. A computer program product comprising:
one or more computer readable storage media and program instructions stored on the one or more computer readable storage media, the program instructions comprising:
program instructions to extract of structured information for unstructured document analysis wherein extracting of structured information for unstructured document analysis comprise:
program instructions to identify tables and columns of a database that correspond to business terms of a business glossary;
program instructions to receive a specification of business terms of interest for recognizing in an unstructured document;
program instructions to generate an analysis module based on the identified tables and columns that enables to identify or recognize attribute values of attributes of the tables and columns; and
program instructions to use the analysis module for automatic extraction of values of at least part of the attributes from the unstructured document based on the specification of business terms of interest.

12. The computer program product of claim 11, wherein the program instructions to identify of the tables and columns comprise:
for each term of a plurality of business terms, program instructions to determine an identification logic based on a format and content of a respective business term; and
program instructions to run the identification logics on the database for identifying the tables and columns.

13. The computer program product of claim 11, wherein the program instructions to generate the analysis module comprise:
program instructions to build a dictionary of the plurality of business terms using attribute values of the identified tables and columns, wherein using the analysis module to extract the structured information comprise program instructions to compare content of the unstructured document with the dictionary.

14. The computer program product of claim 11, wherein the program instructions to generate the analysis module comprise:
program instructions to build a logic based on the content and format of the attribute values of the identified tables and columns such that the logic can recognize values similar to the attribute values.

15. The computer program product of claim 11, wherein the program instructions stored on the one or more computer readable storage media further comprise:
program instructions to update the analysis module based on one or more changes in the database and the business glossary; and
program instructions to continually update the analysis module for extraction of structured information from the unstructured document and/or form another unstructured document.

16. A computer system for comprising:
one or more computer processors;
one or more computer readable storage media; and
program instructions stored on the one or more computer readable storage media for execution by at least one of the one or more computer processors, the program instructions comprising:
program instructions to extract of structured information for unstructured document analysis wherein extracting of structured information for unstructured document analysis comprise:
program instructions to identify tables and columns of a database that correspond to business terms of a business glossary;
program instructions to receive a specification of business terms of interest for recognizing in an unstructured document;
program instructions to generate an analysis module based on the identified tables and columns that enables to identify or recognize attribute values of attributes of the tables and columns; and
program instructions to use the analysis module for automatic extraction of values of at least part of the attributes from the unstructured document based on the specification of business terms of interest.

17. The computer system of claim 11, wherein the program instructions to identify of the tables and columns comprise:
for each term of a plurality of business terms, program instructions to determine an identification logic based on a format and content of a respective business term; and
program instructions to run the identification logics on the database for identifying the tables and columns.

18. The computer system of claim 11, wherein the program instructions to generate the analysis module comprise:
program instructions to build a dictionary of the plurality of business terms using attribute values of the identified tables and columns, wherein using the analysis module to extract the structured information comprise program instructions to compare content of the unstructured document with the dictionary.

19. The computer system of claim 11, wherein the program instructions to generate the analysis module comprise:
program instructions to build a logic based on the content and format of the attribute values of the identified tables and columns such that the logic can recognize values similar to the attribute values.

20. The computer system of claim 11, wherein the program instructions stored on the one or more computer readable storage media further comprise:
program instructions to update the analysis module based on one or more changes in the database and/or the business glossary; and
program instructions to continually update the analysis module for extraction of structured information from the unstructured document and/or form another unstructured document.
